(19) United States
(12) Patent Application Publication
(10) Pub. No.: US 2009/0191993 A1
(43) Pub. Date: Jul. 30, 2009

(54) Variator Structure

(76) Inventor: I Lin, Taipei (TW)

Correspondence Address: Chung Chang, 7 Marlboro Road, Lexington, MA, 02421, US

(21) Appl. No.: 12/264,410

(22) Filed: Nov. 4, 2008

(30) Foreign Application Priority Data
Jan. 25, 2008 (TW) 97201754

(51) Int. Cl. F16H 55/56

(52) U.S. Cl. 474/13

(57) ABSTRACT

An improvement of the pulley set structure connects the clutch assembly by a belt for the convey of the power, comprising a variator and a fan impeller. One side of the fan impeller is designed to form a setup of indentations and protrusions, which is to boost the transmission coefficient between the fan impeller and the belt; the variator is provided with a plurality of grooves allocated with rollers or weights, a skirt portion made of a rigid wall which is located near the rim of the variator, and a plurality of vents formed onto the grooves and the skirt portion, where the purpose is to improve the dissipation of the excessive heat generated by the rolling of the rollers or weights which in turn are activated by the engine, or to improve the skid and incomplete transmission subject to inefficient friction between the pulley set and the belt.

### BACKGROUND OF THE INVENTION

1. Field of the Invention

The present invention relates to the improvement of a pulley set structure which is operated in coordination with the clutch assembly. More particularly, the invention relates to a pulley set structure that features bulky dissipation and substantially avoiding going into a skid.

2. Background of the Invention

The application of the power transmission device of the Continuous Variable Transmission (CVT) system in the motor vehicles has been a prior art. Basically, the automatic shift transmission apparatus makes use of the centrifugal force to move the gear shifting components in order to change the torque ratio; comprising a pulley set where power is transmitted from the engine connecting rod, and a clutch assembly (or centrifugal transmission) which is driven by the pulley set through a belt, where the power driving the pulley set is relayed by the engine connecting rod, through the belt to actuate the clutch assembly, the power is then conveyed to the boss of the clutch assembly, and eventually makes the vehicle wheels move.

In general, the pulley set comprises a variator linked by the engine connecting rod, and a fan impeller; the variator is provided with a plurality of grooves spaced at intervals at its one side for accommodating rollers or weight. During the running of engine, the rollers of the variator roll on at high speed along the grooves, subject to the centrifugal force, which makes the variator to press the belt to slide outward or toward the direction of the fan impeller; therefore, the other end of the belt will slide toward the inner side of the torque plate of the clutch assembly; by means of the sliding of the transmission belt to alter the shift ratio, which brings about the response of acceleration.

Once the conventional pulley set is put into a whole, the variator is being sealed; as the rollers or weights roll on at high speed as a result of the running of engine, the excessive heat generated couldn't be discharged from the variator, so that the rollers or the weights are kept to stay in a high temperature state, where the thermal wear drains the diameter and the weight of the rollers or weights to make them shrunk gradually. As the rollers or weights are shrunk to a certain level, they will fail to force the variator to press the belt for altering the shift ratio which could facilitate to arrive at the expected speed.

In order to improve the aforementioned, the prior art have disclosed a conception of the means capable to dissipate heat from the variator. For instance, ROC Patent No. 96203204 “ventilation slide belt wheel” offers a typical embodiment. The variator is provided with air vents at its grooves in which the rollers or weights are placed, which targets to discharge the excessive heat through the air vents to the outside. However, those skilled in the art would know that there are inherent constraints for the specific type of variator structure, so that the heat dissipation is not good for the ones with vents only at the grooves.

Another application on pulley set is in the aforesaid, which relates to a power transmission apparatus that forces the variator to press the belt to slide outward or toward the direction of the fan impeller to alter the shift ratio. As in an application, the pulley set or the fan impeller currently is prone to adopt substance (for instance: steel, aluminum alloy) of rigid structure and hard to deform at high temperature, its coefficient of friction is then relatively low; as the belt slides toward the fan impeller, phenomena of going into a skid and incomplete transmission will be sometimes aroused due to the insufficient friction for the power transmission, which gives rise to loss of power, and this is not what we expected.

Accordingly, this reference documents show the applications of the pulley set or other components related to the art of power transmission for motor vehicles. If there is any effort that designs the pulley set anew, making its structure different from the prior art, the design then could alter the usage, which is construed to be novel. For instance, under a specific type of variator structure, any structure designs that bring in huge dissipation, or substances that enables endurance for high temperature and hard to deform but with high coefficient of transmission or friction, to reduce the skid and incomplete transmission, which brings about the boosting efficiency of the power transmission. These topics are not disclosed in the aforesaid prior art.

### SUMMARY OF THE INVENTION

The objective of the present invention is to provided an improvement of the pulley set structure, which connects to the clutch assembly by a belt for the convey of the power, comprising a variator and a fan impeller. One side of the fan impeller is designed to form a setup of indentations and protrusions, which is to boost the transmission coefficient between the fan impeller and the belt; the variator is provided with a plurality of grooves allocated with rollers or weights, a skirt portion made of a rigid wall which is located near the rim of the variator, and a plurality of vents formed onto the grooves and the skirt portion, where the purpose is to improve the dissipation of the excessive heat generated by the rolling of the rollers or weights which in turn are activated by the engine, or to improve the skid and incomplete transmission subject to inefficient friction between the pulley set and the belt.

According to the improvement of the pulley set structure of the present invention, the variator is provided with a plurality of vents onto the skirt portion; the mentioned vents are disposed along the edge of the skirt.

According to the improvement of the pulley set structure of the present invention, the fan impeller comprises a first side allocated with a plurality of vanes thereon, and a second side designed with a setup of indentations and protrusions thereon.

The novelty, traits, other objects and functionality of the present invention will be clearly comprehended by referring to the following detailed description in conjunction with the accompanying drawings.

### BRIEF DESCRIPTION OF THE DRAWINGS

FIG. 1 is a schematic diagram of the exemplified embodiment of the combination of the present invention, the belt, and the clutch assembly;

FIG. 2 is an exploded view of the structure of the pulley set of the present invention;

FIG. 3 is a three-dimensional sectional view of the structure of the variator of the present invention; and

FIG. 4 is a schematic plan view of the variator.

### DETAILED DESCRIPTION OF THE PREFERRED EMBODIMENTS

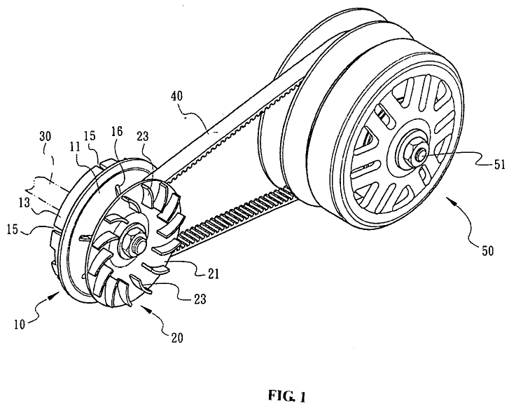

Referring to FIGS. 1 & 2, an improvement of the pulley set structure of the present invention comprises a variator 10 and a fan impeller 20. FIG. 1 shows the pulley set, made up of the variator 10 and the fan impeller 20, is designed to join the engine connecting rod 30, and a belt 40 is for the connection between the pulley set and the clutch assembly 50, where the power originated from the engine connecting rod 30 is relayed to the clutch assembly 50 through the belt 40, again to the boss 51 of the clutch assembly 50, and lastly to make the vehicle wheels move.

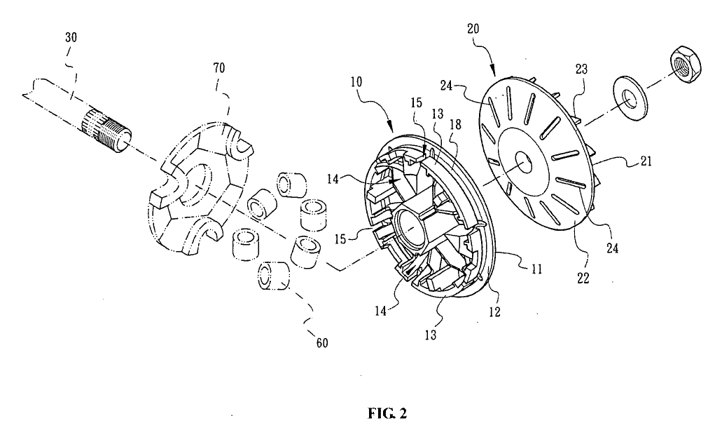

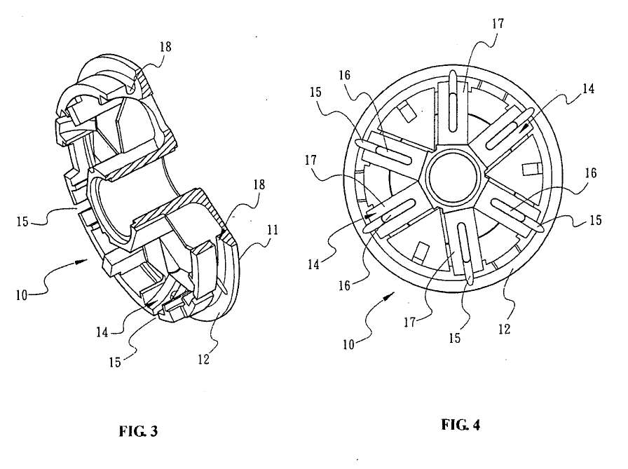

Referring to FIGS. 2-4, in the exemplified embodiment of the present invention, the variator 10 is designed to adopt substance (for instance: steel, aluminum alloy) of more rigid structure and being hard to deform at high temperature for production; comprising a first side 11, and a second side 12 which is cone in shape, relatively to the first side 11; and a skirt portion 13 in rigid wall located along the edge of the second side 12 or the rim of the variator 10. The second side 12 is provided with a plurality of grooves 14 spaced at intervals for lodging rollers or weights, followed by a shell cover 70 to form a closed space together with the variator 10. Every groove 14 is provided with gaps 15 and vents 16; the vent 16 is like a rectangle or a slender shape, disposed at the bottom 17 of the grooves 14 along the radial of the variator 10, shown in FIG. 4.

In a preferred exemplified embodiment, the skirt portion 13 of the variator 10 is provided with a plurality of vents 18; the vent 18 is like a rectangle or a slender shape, disposed along the rim of the skirt portion 13. Under a viable realization, the shape and position of the vents 16, 18 are changeable and modifiable. It is apparent that the structure having gaps 15 and vents 16, 18 for the variator 10 is simply maximizing the contact scope with the outside, to substantially raise the heat dissipation.

Referring to FIG. 2, the fan impeller 20 is able to adopt substance (for instance: steel, aluminum alloy) of more rigid structure and being hard to deform at high temperature for production; which is characterized physically into a first side 21 and a second side 22; the first side 21 is provided with a plurality of vanes 23. In a preferred embodiment, the second 22 is provided with a setup 24 of indentations and protrusions; the setup 24 of indentations and protrusions in the embodiment of the present invention, takes the rectangle or a slender shape, disposed along the radial of the fan impeller 20. Under a viable realization, the shape and position of the setup 24 of indentations and protrusions are changeable and modifiable. It is apparent that the structure of the fan impeller 20 having the setup 24 of indentations and protrusions is simply making the second side 22, connecting the fan impeller 20 and the belt 40, has the bigger transmission coefficient or friction, to improve the lacking of friction so that the skid and incomplete transmission can be effectively avoided.

Overall, the improvement of the pulley set structure of the present invention, under the conditions of preserving enough structural strength and of limited space of the variator 10, is provided with a structure having gaps 15 and vents 16, 18, which is a useful means to raise the contact with the outside, for the sizable discharge of heat; the heat dissipation has been considerably boosted by comparing with the prior art structure of the variators. Meanwhile, the structural design of the pulley set is to equip the fan impeller 20 with the setup 24 of indentations and protrusions, which helps to make the transmission between the pulley set and the belt 40 to have bigger transmission coefficient or friction. These are not found in the disclosure of the prior art. The present invention has made a tremendous improvement, which has been fully in compliance with the requirements of invention patentability.

The aforesaid description is a preferred exemplified embodiment of the present invention, and it is apparent that the disclosed subject matter is not considered to be restrictive to the scope of the realization of the present invention, that is, any equivalent variations and modifications without departing from the spirit and scope of the present invention are therefore intended to be embraced.

What is claimed is:

1. An improvement of pulley set structure, comprising a variator and a fan impeller; where the variator comprises:
a first side and a second side, where the first side is provided with a plurality of grooves, for accommodating rollers and weights;
a skirt portion in rigid wall disposed along the rim of said variator; and
a plurality of vents formed into the grooves and the skirt portion.

2. An improvement of pulley set structure as in claim 1 wherein the fan impeller comprises a first side which is provided with a plurality of vanes and a second side; the second side being form with indentations and protrusions.

3. An improvement of pulley set structure as in claim 1 wherein the grooves are formed with gaps and vents.

4. An improvement of pulley set structure as in claim 1 or claim 3 wherein the vents take the rectangle or a slender shape.

5. An improvement of pulley set structure as in claim 1 or claim 3 wherein the vents are located at the bottom of the grooves along the radial of the variator.

6. An improvement of pulley set structure as in claim 1 wherein the variator is provided with a plurality of vents at its skirt portion; the vents take the rectangle or a slender shape.

7. An improvement of pulley set structure as in claim 6 wherein the vents are disposed along the rim of the skirt portion.

8. An improvement of pulley set structure as in claim 2 wherein the setup of the indentations and protrusions take the rectangle or a slender shape.

9. An improvement of pulley set structure as in claim 2 wherein the setup of the indentations and protrusions are disposed along the radial the fan impeller.
